(19) United States
(12) Patent Application Publication
(10) Pub. No.: US 2012/0226581 A1
(43) Pub. Date: Sep. 6, 2012

(54) SHOPPING INFORMATION FLOW SYSTEM AND METHOD BY DIGITAL RADIO CHANNEL AND COMMUNICATION NETWORK

(75) Inventor: Chao-Tung Yang, Hsinchu (TW)

(73) Assignee: KEYSTONE SEMICONDUCTOR CORP, Hsinchu (TW)

(21) Appl. No.: 13/165,766

(22) Filed: Jun. 21, 2011

(30) Foreign Application Priority Data
Mar. 3, 2011 (TW) 100107146

(51) Int. Cl. G06Q 30/00

(52) U.S. Cl. 705/26.41

(57) ABSTRACT

A shopping information flow system and method by a digital radio channel and a communication network are provided, and are suitable for an electronic device with a playing digital broadcasting function. The method includes the following steps: a digital radio broadcasting station broadcasting a program signal and a sales information, in which a virtual store providing the sales information on a commodity; the electronic device receiving and playing the program signal, and displaying the sales information; the electronic device starting a web link to connect an authentication terminal, transmitting an identification information of the electronic device for processing a transaction identification; and the authentication terminal processing a sale deal of the commodity, thereby noticing the virtual store to supply the commodity to a user of the electronic device. This can be done to sell the commodity.

### CROSS-REFERENCE TO RELATED APPLICATION

This application claims the priority benefit of Taiwan application serial no. 100107146, filed on Mar. 3, 2011. The entirety of the above-mentioned patent application is hereby incorporated by reference herein and made a part of this specification.

### BACKGROUND OF THE INVENTION

1. Field of the Invention

The invention relates to an electronic marketing system and method, and more particularly to a shopping information flow system and method by a digital radio channel and a communication network.

2. Description of Related Art

Typical business men require to an actual store to buy and sell products, and the sale of the commodities will be affected by the weather. For example, a rainy day will cause less people to go outside. The sale of commodities will also be affected by the stream of people. In addition, actual stores will have a higher operation cost, and will result in reduced profits. Thus, many people use virtual stores to sell commodities on the internet, allowing more people to browse and buy commodities.

However, there are many internet virtual stores, and consumers need to search for commodities and compare prices. This passive selling method can not effectively stimulate buying, and store owners have the risk of storing commodities.

Thus, an active commodity marketing method giving consumers convenience to buy products is a topic to be dealt with.

### SUMMARY OF THE INVENTION

The invention provides a shopping information flow system by a digital radio channel and a communication network, including a virtual store, a digital radio broadcasting station, an authentication terminal, and an electronic device. The virtual store provides a sales information and a commodity. The digital radio broadcasting station receives the sales information, and is used to broadcast a program signal and the sales information. The authentication terminal is used for processing a sale deal of the commodity. The electronic device has a playing digital broadcasting function, and displays the sales information when playing the program signal. Wherein, since the electronic device starts a web link to connect to the authentication terminal, an identification information of the electronic device is transmitted through the web link for processing a transaction identification, and the authentication terminal notices the virtual store to supply the commodity to a user of the electronic device.

The invention further provides a shopping information flow method by a digital radio channel and a communication network, suitable for an electronic device with a playing digital broadcasting function. The method includes the steps below. A digital radio broadcasting station broadcasts a program signal and a sales information, in which a virtual store provides the sale information of a commodity. The electronic device receives and plays the program signal, and displays the sales information. The electronic device starts a web link to connect an authentication terminal, and transmits an identification information of the electronic device for processing a transaction identification. Finally, the authentication terminal processes a sale deal of the commodity, and notices the virtual store to supply the commodity to a user of the electronic device.

In an embodiment of the invention, the authentication terminal stores a payment information after confirming the identification information has no error, and notices the virtual store according to the user information represented by the identification information.

In an embodiment of the invention, the sales information is a picture or a video.

In an embodiment of the invention, a broadcast system of the digital radio broadcasting station is a digital audio broadcasting system, a digital multimedia broadcasting system, a digital multimedia broadcast-terrestrial/handheld system, a high-definition radio broadcasting system, or a digital radio mondiale system.

In an embodiment of the invention, the web link is a global system for mobile, a third generation mobile system, a third generation partnership project long term evolution advanced system, or an ethernet link.

In an embodiment of the invention, the authentication terminal is a telecommunication terminal or a payment gateway.

In an embodiment of the invention, the authentication terminal further manages a sales quantity and profit of the commodity according to the sales information.

In an embodiment of the invention, the identification information includes a user account and a password.

In an embodiment of the invention, the authentication terminal updates a transaction record of the user and provides the user with a consumer report according to the identification information and a payment information.

In an embodiment of the invention, the shopping information flow system further includes a first data server, the first data server connects the digital radio broadcasting station and the authentication terminal, and the first data server is used to process electronic sales of the commodity.

In an embodiment of the invention, the shopping information flow system further includes a first data server, the digital radio broadcasting station includes a first data server, the authentication terminal includes a second data server, and the first data server and the second data server are connected and process electronic sales of the commodity.

To make the above features and advantages of the invention more comprehensible, several embodiments accompanied with drawings are described in detail as follows.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a schematic view a shopping information flow system according to an embodiment of the invention.

FIG. 2 is a schematic view a shopping information flow system according to another embodiment of the invention.

FIG. 3 is a schematic view a shopping information flow system according to another embodiment of the invention.

FIG. 4 is a schematic view a shopping information flow system according to another embodiment of the invention.

FIG. 5 is a schematic view a shopping information flow system according to another embodiment of the invention.

FIG. 6 is a flowchart illustrating a shopping information flow method according to an embodiment of the invention.

### DESCRIPTION OF EMBODIMENTS

Reference will now be made in detail to the exemplary embodiments of the invention, examples of which are illustrated in the accompanying drawings. In addition, whenever possible, identical or similar reference numbers stand for identical or similar elements in the figures and the embodiments.

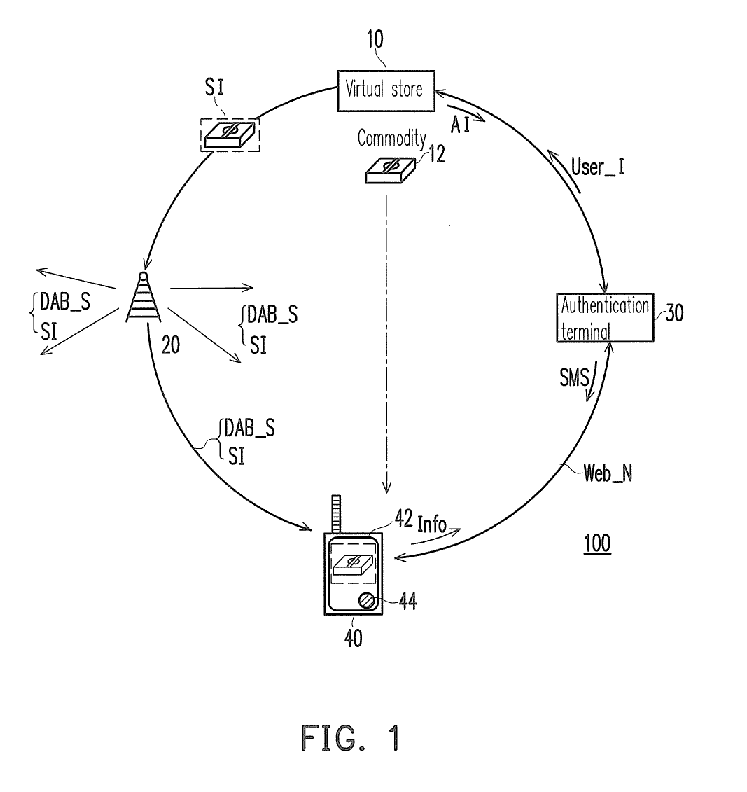

FIG. 1 is a schematic view a shopping information flow system according to an embodiment of the invention. Please refer to FIG. 1. A shopping information flow system 100 can include a virtual store 10, a digital radio broadcasting station 20, an authentication terminal 30, and an electronic device 40.

The virtual store 10 can be a merchant or a vendor. The virtual store 10 provides a sales information SI and a commodity 12. For example, the virtual store 10 can buy and sell presents during Christmas, and display the sales information SI of the presents as a picture or a video (animation) to show the price and content of the presents. The virtual store 10 authorizes the vendor of the digital radio broadcasting station 20 to broadcast the sales information SI. The type of commodities can change. For example, commodities can be chocolate or ornaments, but is not limited thereto.

The vendor of the digital radio broadcasting station 20 can collaborate with a trustworthy merchant or vendor. Since the content of the digital radio broadcasting program can transmit audio frequency, words, pictures, binary information, or video frequency, the digital radio broadcasting station 20 can broadcast the sales information SI while broadcasting a program signal DABS. The program signal DAB_S can be the audio frequency of a program content or the audio frequency signal and the word signal of the program content.

A digital broadcasting system of the digital radio broadcasting station 20 can be a digital audio broadcasting (DAB) system, a digital multimedia broadcasting (DMB) system, a digital multimedia broadcast-terrestrial/handheld (DMB-TH) system, a high-definition radio broadcasting system, or a digital radio mondiale (DRM) system, but is not limited thereto.

The electronic device 40 of the user (consumer) has a playing digital broadcasting function. The electronic device 40 receives the program signal DAB_S and the sales information SI from the digital radio broadcasting station 20. The electronic device 40 plays the program signal DAB_S, so the user receives the audio and also knows the current station name and frequency channel. When the electronic device 40 receives the sales information SI, the user can see the commodity advertisement from a screen 42 of the electronic device 40. For example, when playing the program signal DAB_S, the electronic device 40 executes an application program, wherein the application program can cause the screen 42 of the electronic device 40 to display the commodity advertisement of the sales information SI. Before intruding on the user to see the commodity advertisement, the application program first can ask the user if he or she wants to browse the advertisements of the broadcasting program. If the user does not wish to disturbed, he or she can choose to not browse the commodity advertisements, and the electronic device 40 will not play the sales information.

If the user wants to browse the commodity advertisements, the application program will display the sales information SI directly on the screen 42, so that the screen 42 displays the sales information. The sales information can be a static picture or an animated video. For example, the sales information can be a video of the apparel on a model. Thus, the shopping information flow system 100 can display the sales information SI of products on the electronic device 40, and can actively promote different commodities effectively, allowing users to know the content and price of commodities when seeing a picture or a video. Regarding the sales promotion of instant commodities or the flow of limited commodities, a broadcasting method can transmit different commodity advertisements with a digital broadcasting program. This way, commodities can be actively promoted and a buying mentality can be effectively stimulated.

In an embodiment, the method of broadcasting the sales information can be separated in different time segments, or commodities that are easily promoted may be pushed for during holidays. Thus, managing the storage of commodities in the virtual store 10 is low, and service is effectively improved, lowering management costs.

When the user sees a favorable commodity, a buy button can be pressed, wherein the buy button can be a virtual button 44 on the touch panel of the electronic device, or the electronic device 40 has a tangible button. When the buy button is pressed, the application program of the electronic device 40 can build a web link Web_N of the commodity for the electronic device 40 and an authentication terminal 30 of the far terminal. The authentication terminal 30 is used for managing a detailed transaction process of the commodity 12.

The authentication terminal 30 can be a telecommunication terminal, a payment gateway, or other information processing organizations provided by a vendor (for example, a telecommunication vendor, but is not limited thereto), but is not limited thereto.

It should be noted that the method of the web link Web_N is building a channel of a secure authentication mechanism. The web link Web_N can be a wireless link or a wired link. The web link Web_N is carried out as a global system for mobile (GSM), a third generation mobile (3G) system, a third generation partnership project long term evolution advanced (3GPP LTE-Advanced) system, or an ethernet, but is not limited thereto.

Next, through the web link Web_N, the electronic device 40 can transmit an identification information Info of the user to the authentication terminal 30, so a specific vendor can confirm the transaction identification process of buying the commodity 12. The identification information Info represents the user data information, and can be the user account and password, or the credit card account and password, but is not limited thereto. This type of electronic business needs an authentication mechanism. The design of the secure authentication mechanism and the execution method is not limited.

The authentication terminal 30 processes a sale deal of the commodity 12, to manage a detailed transaction process of the commodity 12. After confirming the identification information Info of the user has no error, the virtual store 10 is noticed to provide the commodity 12 to the user of the electronic device 40.

In another embodiment, after the authentication terminal 30 confirms the identification information Info has no errors, it stores a payment information (not shown), and notices the virtual store 10 according to the user information represented by the identification information Info.

In yet another embodiment, the authentication terminal 30 can reply a buying certificate SMS to the user, and the buying certificate SMS can be a short message service, but is not limited thereto. Furthermore, the authentication terminal 30 provides information to the virtual store 10 according to the user information User_I represented by the identification information Info. Then, the virtual store 10 provides the commodity 12 to the user according to the user information (for example, the address).

In addition, the authentication terminal 30 further manages a sales quantity and profit of the commodity 12 according to the sales information SI. The authentication terminal 30 updates a transaction record of the user and provides the user with a consumer report according to the identification information Info and a payment information. When the virtual store 10 provides the commodity 12, the virtual store 10 can reply a supply information AI to the authentication terminal 30. The authentication terminal 30 can record the detailed transaction process, and then bill the user.

In another embodiment, the electronic device 40 can be a mobile phone, but this is an optional embodiment, and the invention is not limited thereto. Since each mobile phone has specific identification number, the authentication terminal 30 can know the user according to the identification number of the mobile phone. For example, the telecommunication vendor can use an invoice to bill the user of the mobile phone or directly deduct from a deposit.

It should be noted that although the above embodiments have disclosed a possible type of the shopping information flow system 100, it is common sense to persons of ordinary knowledge in the art the application of the invention should not be limited to this type only. In other words, if the electronic device can play a digital broadcast program, browse commodity advertisements, and build a web link for the authentication terminal, it conforms to the spirit of the invention. Some other embodiments are further discussed hereinafter to allow persons of ordinary skill in the art to comprehend and embody the invention.

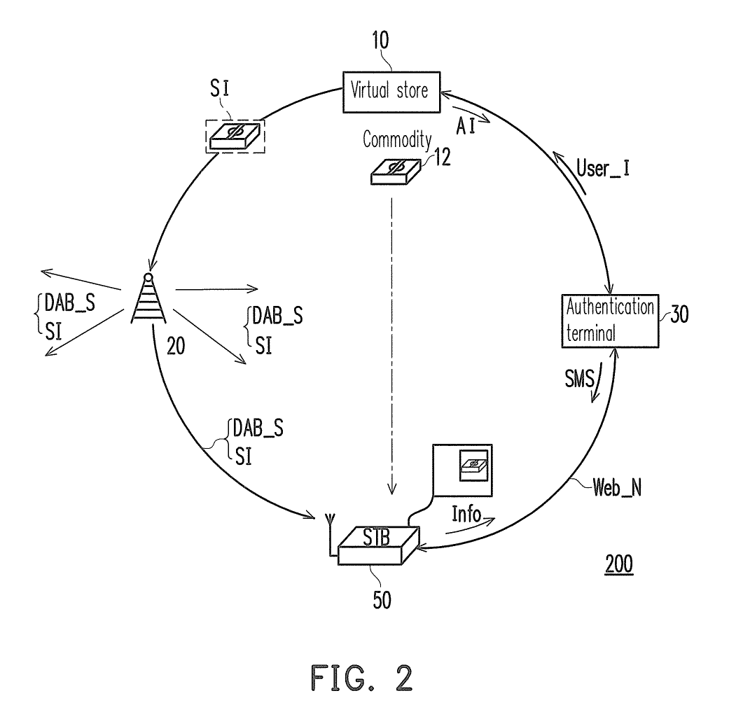

According to the content taught by the above embodiment, FIG. 2 is a schematic view a shopping information flow system according to another embodiment of the invention. Please refer to FIG. 2. The structure of a shopping information flow system 200 is similar to the structure shopping information flow system 100. The difference is the electronic device of the embodiment can be a terrestrial/satellite set top box system 50 with a function of receiving digital broadcasts. The set top box (STB) system 50 can include a mobile phone. The system can be a web link Web_N for the authentication terminal 30 through the mobile phone, or the STB system 50 can build a wired web link Web_N for the authentication terminal 30 with an ethernet.

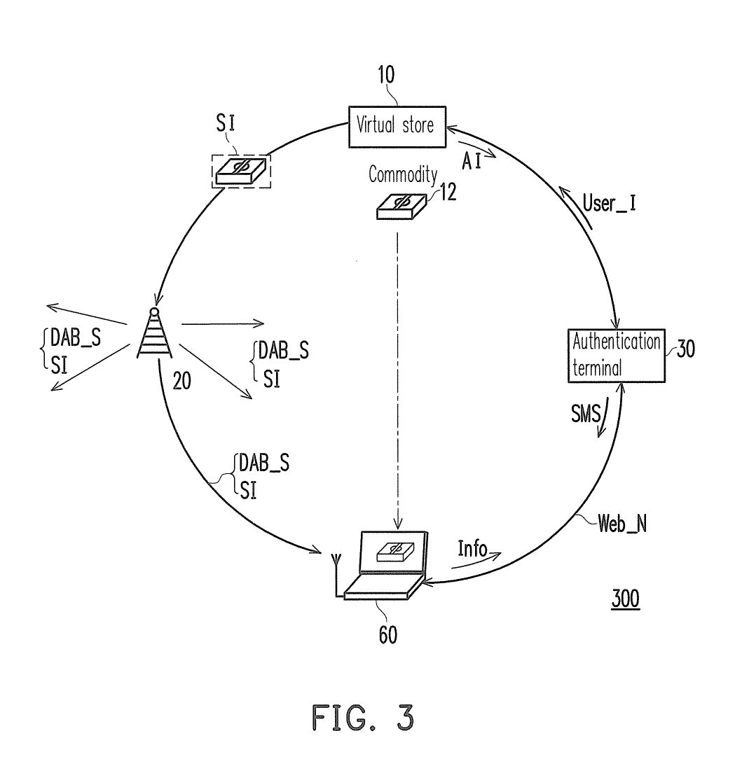

FIG. 3 is a schematic view a shopping information flow system according to another embodiment of the invention. Please refer to FIG. 3. The structure of a shopping information flow system 300 is similar to the structure shopping information flow system 100. The difference is the electronic device of the embodiment can be a laptop computer 60 with a function of receiving digital broadcasts. The laptop computer 60 can build a web link Web_N for the authentication terminal 30 through a wireless or wired method. Therefore, persons having ordinary knowledge in the art may make other changes according to the substantial configuration of the electronic device, and the invention is not limited to the types above.

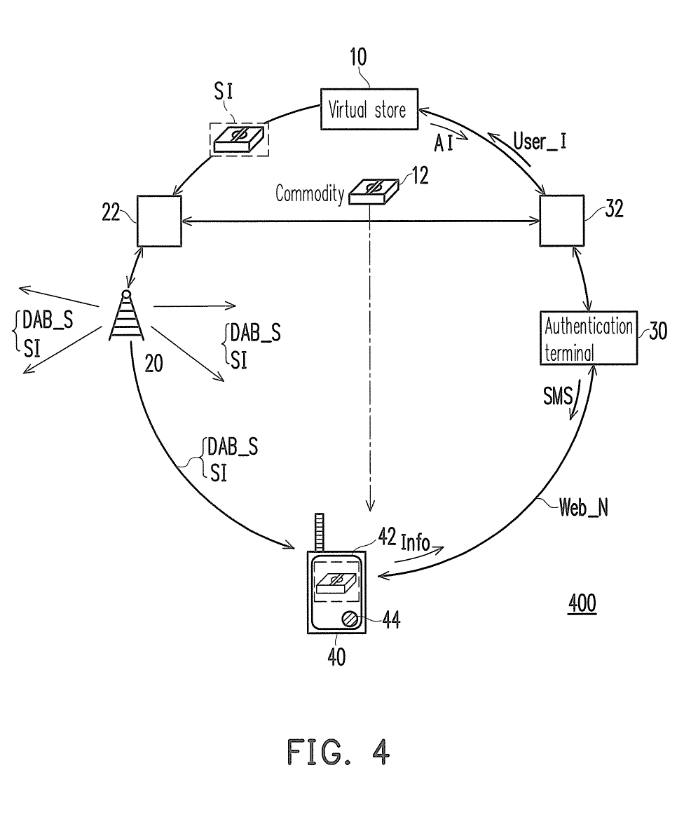

FIG. 4 is a schematic view a shopping information flow system according to another embodiment of the invention. Please refer to FIG. 4. The structure of a shopping information flow system 400 is similar to the structure shopping information flow system 100. The difference is, the shopping information flow system 400 can further include a first data server 22 and a second data server 32. The first data server 22 and the second data server 32 are hardware, and can be used to process the electronic sale of different commodities. The virtual store 10 first transmits the sales information SI to the first data server 22. The digital radio broadcasting station 20 then reads the sales information SI from the first data server 22, and broadcasts the information.

For example, the vendor of the digital radio broadcasting station 20 provides the first data server 22, and another vendor provides the second data sever 32. Besides providing the sales information SI of the commodity, the virtual store further provides the quantity and price of the commodity to the first data server 22 and the second data server 32. The first data server 22 and the second data server 32 can store the sale information and quantity of the commodity. The playing of advertisements by the digital radio broadcasting station 20 is according to the first data server 22. The authentication terminal 30 can be connected to the second data server 32, and the authentication terminal 30 can record the detailed transaction processes in the second data server 32. The first data server 22 and the second data server 32 can be connected, and process the sales of the commodities (for example, the quantity and the price). When the commodity changes, or is sold, the information in the first data server 22 and the second data server 32 are synchronously recorded and updated.

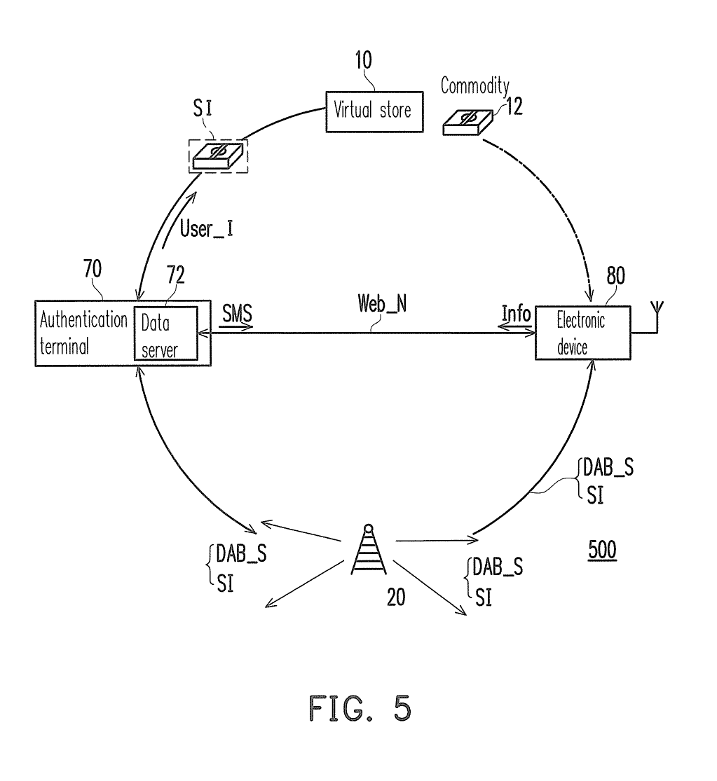

FIG. 5 is a schematic view a shopping information flow system according to another embodiment of the invention. Please refer to FIG. 5. The structure of a shopping information flow system 500 is similar to the structure shopping information flow system 100. A shopping information flow system 500 can include a virtual store 10, an authentication terminal 70, a digital radio broadcasting station 20, and an electronic device 80. The authentication terminal 70 includes a data server 72, or the authentication terminal 70 is connected to the data server 72. The authentication terminal 70 is used for managing a detailed transaction process of the commodity 12. The electronic device 80 can be a mobile phone, an STB system, or a laptop computer with a function for receiving digital broadcasting, but is not limited to the machines thereto.

The virtual store 10 authorizes the vendor of the digital radio broadcasting station 20 to broadcast the sales information SI. The virtual store 10 first transmits the sales information SI to the data server 72. The digital radio broadcasting station 20 then reads the sales information SI from the data server 72, and broadcasts the information. Besides listening to the broadcast program, the electronic device 80 of the user can also browse commodity advertisements and obtain sales information. The electronic device 80 has a buy button. The buy button can be a tangible button or a virtual button on the touch panel.

When user finds a favorable commodity, he or she can press a buy button of the electronic device 80, and a web link Web_N of the commodity is built for the electronic device 80 and an authentication terminal 70 of the far terminal. The web link Web_N can be a wireless link or a wired link. The web link Web_N is carried out through a GSM system, a 3G system, a 3GPP LTE-Advanced system, or an ethernet, but is not limited thereto.

Next, through the web link Web_N, the electronic device 80 can transmit an identification information Info of the user to the authentication terminal 70, so the transaction identification process of buying the commodity 12 is confirmed. The identification information Info represents the user data information, and can be the user account and password, or the credit card account and password, but is not limited thereto. The authentication terminal 70 processes a sale deal of the commodity 12, for example, managing a detailed transaction process of the commodity 12, and recording it in the data server 72. After confirming the identification information Info of the user has no error, the virtual store 10 is noticed to provide the commodity 12 to the user of the electronic device 80.

In another embodiment, the authentication terminal 70 can be provided by a trustworthy vendor organization. Thus, all expenses and management generated by transactions and services can be planned by the vendor organization. For example, the vendor organization can request transaction fees from the user or divide reasonable profits relating to the marketing of the commodity according to the detailed transaction process of the authentication terminal 70.

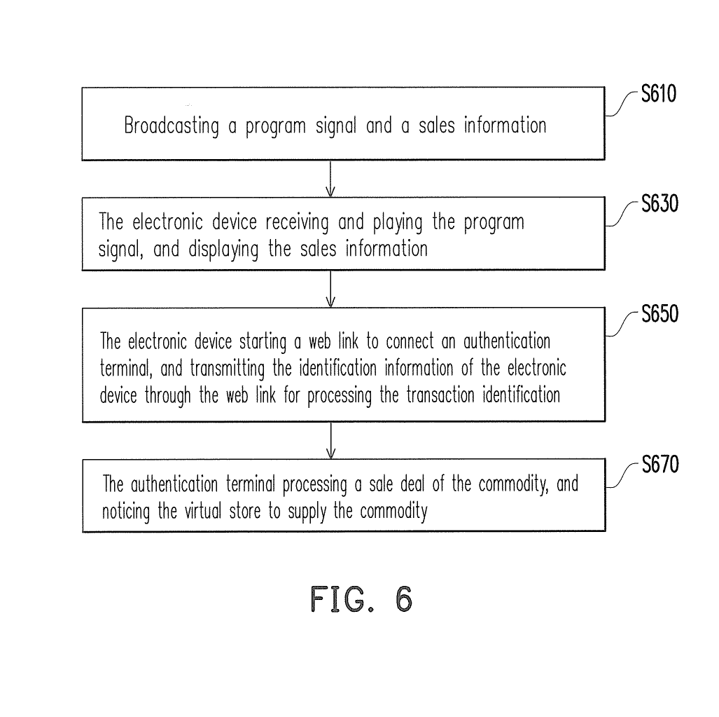

From the description of the aforementioned embodiments, FIG. 6 is a flowchart illustrating a shopping information flow method according to an embodiment of the invention. Please simultaneously refer to FIG. 1 and FIG. 6. The shopping information flow method of the embodiment includes the following steps.

The digital radio broadcasting station 20 broadcasts a program signal DAB_S and a sales information SI, wherein the virtual store 10 provides the sales information SI of a commodity 12 (step S610).

The electronic device 40 receives and plays the program signal DAB_S, and displays the sales information SI (step S630).

The electronic device 40 starts a web link Web_N to connect an authentication terminal 30, and transmits the identification information Info of the electronic device 40 through the web link Web_N for processing the transaction identification (step S650).

The authentication terminal processes a sale deal of the commodity 12, and notices the virtual store to supply the commodity to a user of the electronic device 40 (step S670).

The shopping information flow system and method of the embodiments can allow the managing of the storage of commodities in the virtual store to be low, and effectively improve and lower management costs. In addition, the system provides prospects and opportunities towards the electronic market industry, and can effectively stimulate consumers to buy commodities, increasing the activities in the economy. Thus, the virtual store, the digital broadcasting vendor, and the authentication terminal vendor can all reap the benefits because of a good economic flow, and increase profits.

To sum up, through the method of digital broadcasting frequency to actively market the commodity, the user can hear the digital radio broadcasting program signal and buy conveniently, further achieving the goal of marketing commodities. As a result, the operation speed of commodity transactions can be increased, and the burden of storing commodities can be reduced.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A shopping information flow system by a digital radio channel and a communication network, comprising:
a virtual store, providing a sales information and a commodity;
a digital radio broadcasting station, receiving the sales information, and used to broadcast a program signal and the sales information;
an authentication terminal, used for processing a sale deal of the commodity; and
an electronic device, with a playing digital broadcasting function, displaying the sales information when playing the program signal;
wherein, since the electronic device starts a web link to connect to the authentication terminal, an identification information of the electronic device is transmitted through the web link for processing a transaction identification, and the authentication terminal notices the virtual store to supply the commodity to a user of the electronic device.

2. The shopping information flow system by the digital radio channel and the communication network as claimed in claim 1, wherein the authentication terminal stores a payment information after confirming the identification information has no error, and notices the virtual store according to the user information represented by the identification information.

3. The shopping information flow system by the digital radio channel and the communication network as claimed in claim 1, wherein the sales information is a picture or a video.

4. The shopping information flow system by the digital radio channel and the communication network as claimed in claim 1, wherein a broadcast system of the digital radio broadcasting station is a digital audio broadcasting system, a digital multimedia broadcasting system, a digital multimedia broadcast-terrestrial/handheld system, a high-definition radio broadcasting system, or a digital radio mondiale system.

5. The shopping information flow system by the digital radio channel and the communication network as claimed in claim 1, wherein the web link is a global system for mobile, a third generation mobile system, a third generation partnership project long term evolution advanced system, or an ethernet.

6. The shopping information flow system by the digital radio channel and the communication network as claimed in claim 1, wherein the authentication terminal is a telecommunication terminal or a payment gateway.

7. The shopping information flow system by the digital radio channel and the communication network as claimed in claim 1, wherein the authentication terminal further manages a sales quantity and profit of the commodity according to the sales information.

8. The shopping information flow system by the digital radio channel and the communication network as claimed in claim 1, wherein the identification information includes a user account and a password.

9. The shopping information flow system by the digital radio channel and the communication network as claimed in claim 1, wherein the authentication terminal updates a transaction record of the user and provides the user with a consumer report according to the identification information and a payment information.

10. The shopping information flow system by the digital radio channel and the communication network as claimed in claim 1, wherein the shopping information flow system further includes a first data server, the first data server connects the digital radio broadcasting station and the authentication terminal, and the first data server is used to process electronic sales of the commodity.

11. The shopping information flow system by the digital radio channel and the communication network as claimed in claim 1, wherein the digital radio broadcasting station includes a first data server, the authentication terminal includes a second data server, and the first data server and the second data server are connected and process electronic sales of the commodity.

12. A shopping information flow method by a digital radio channel and a communication network suitable for an electronic device with a playing digital broadcasting function, the shopping information flow method comprising:
a digital radio broadcasting station broadcasting a program signal and a sales information, wherein a virtual store provides the sales information of a commodity;
the electronic device receiving and playing the program signal, and displaying the sales information;
the electronic device starting a web link to connect an authentication terminal, transmitting an identification information of the electronic device for processing a transaction identification; and
the authentication terminal processing a sale deal of the commodity, and noticing the virtual store to supply the commodity to a user of the electronic device.

13. The shopping information flow method by the digital radio channel and the communication network as claimed in claim 12, wherein the authentication terminal stores a payment information after confirming the identification information has no error, and notices the virtual store according to the user information represented by the identification information.

14. The shopping information flow method by the digital radio channel and the communication network as claimed in claim 12, wherein the sales information is a picture or a video.

15. The shopping information flow method by the digital radio channel and the communication network as claimed in claim 12, wherein a broadcast system of the digital radio broadcasting station is a digital audio broadcasting system, a digital multimedia broadcasting system, a digital multimedia broadcast-terrestrial/handheld system, a high-definition radio broadcasting system, or a digital radio mondiale system.

16. The shopping information flow method by the digital radio channel and the communication network as claimed in claim 12, wherein the web link is a global system for mobile, a third generation mobile system, a third generation partnership project long term evolution advanced system, or an ethernet.

17. The shopping information flow method by the digital radio channel and the communication network as claimed in claim 12, wherein the authentication terminal is a telecommunication terminal or a payment gateway.

18. The shopping information flow method by the digital radio channel and the communication network as claimed in claim 12, wherein the authentication terminal further manages a sales quantity and profit of the commodity according to the sales information.

19. The shopping information flow method by the digital radio channel and the communication network as claimed in claim 12, wherein the identification information includes a user account and password.

20. The shopping information flow method by the digital radio channel and the communication network as claimed in claim 12, wherein the authentication terminal further updates a transaction record of the user and provides the user with a consumer report according to the identification information and a payment information.

21. The shopping information flow method by the digital radio channel and the communication network as claimed in claim 12, wherein a first data server connects the digital radio broadcasting station and the authentication terminal, and the first data server is used to process electronic sales of the commodity.

22. The shopping information flow method by the digital radio channel and the communication network as claimed in claim 12, wherein digital radio broadcasting station includes a first data server, the authentication terminal includes a second data server, and the first data server and the second data server are connected and process electronic sales of the commodity.
